(19) United States
(12) Patent Application Publication
(10) Pub. No.: US 2009/0061719 A1
(43) Pub. Date: Mar. 5, 2009

(54) WATER-SOLUBLE POLYVINYL ALCOHOL RESIN FILAMENT AND NONWOVEN FABRIC MADE BY USING THE SAME

(75) Inventors: Mitsuo Shibutani, Osaka (JP); Norihito Sakai, Osaka (JP)

Correspondence Address: KRATZ, QUINTOS & HANSON, LLP, 1420 K Street, N.W., Suite 400, WASHINGTON, DC, 20005, US

(73) Assignee: The Nippon Synthetic Chemical Industry Co., Ltd., Osaka-shi (JP)

(21) Appl. No.: 12/278,324

(22) PCT Filed: Feb. 6, 2007
(86) PCT No.: PCT/JP2007/052005

§ 371 Date: Aug. 5, 2008

(30) Foreign Application Priority Data
Feb. 7, 2006 (JP) 2006-029863
Feb. 5, 2007 (JP) 2007-025647

(51) Int. Cl. D04H 13/00; B32B 5/02; C08F 116/06

(52) U.S. Cl. 442/327; 428/401; 525/56

(57) ABSTRACT

A water-soluble polyvinyl alcohol resin filament is provided, which is formed by melt-spinning a material consisting essentially of a water-soluble polyvinyl alcohol resin having a 1,2-diol structural unit represented by the following general formula (1). A nonwoven fabric is also provided, which is produced by using the water-soluble polyvinyl alcohol resin filament. Therefore, the nonwoven fabric is excellent in water solubility at a lower temperature, and substantially free from bubbling during dissolution thereof in water. In addition, a fully saponified PVA can be used for melt-forming. This suppresses emanation of acetic acid odor, thereby improving the working environment.

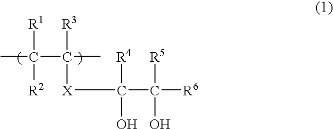

wherein R¹, R², R³, R⁴, R⁵ and R⁶, which may be the same or different, are each a hydrogen atom or a monovalent organic group, and X is a single bond or a connecting chain.

### TECHNICAL FIELD

The present invention relates to a water-soluble polyvinyl alcohol resin (hereinafter referred to as “water-soluble PVA”) filament which is excellent in solubility at a lower temperature and easy to handle for use as a nonwoven fabric material for embroidery bases such as chemical laces, automotive scratch protection materials, filters, medical surgery gowns and the like, and to a nonwoven fabric made by using the water-soluble PVA filament.

### BACKGROUND ART

Products produced from water-soluble resin filaments and woven or nonwoven fabrics made of the water-soluble resin filaments are conventionally used in various applications. Particularly, fiber products made of a PVA, which have higher tensile strength, are used in a variety of fields.

It is known that the production of the nonwoven fabric from the PVA is achieved, for example, by spinning the PVA into the nonwoven fabric by a wet spinning method. The prior-art nonwoven fabric, though thus produced from the water-soluble PVA, is generally dissoluble in hot water at a high temperature on the order of 90° C. Therefore, where the nonwoven fabric is used as a so-called embroidery base such as a chemical lace base, for example, the nonwoven fabric base should be dissolved in hot water, resulting in discoloration of embroidery and degradation of embroidery threads.

A filament and a nonwoven fabric produced from a partially saponified PVA by a melt-forming method are also known. However, acetic acid odor is liable to emanate due to detachment of side-chain —OCOCH₃ during the melt-forming, resulting in problems such as deterioration of working environment and rusting of a forming machine. On the other hand, where a fully saponified PVA is used, the resulting product has a higher crystallinity and a correspondingly higher melting point, so that the melt-forming is difficult. Further, a water-soluble PVA filament which is formed by a wet solvent cooling gel spinning method as having specific properties and is dissoluble in water at a temperature not higher than 100° C. is disclosed as a highly water-soluble and easy-to-handle filament (see Patent Document 1).

### Patent Document 1: JP-A-7 (1995)-90714

### DISCLOSURE OF THE INVENTION

### Problems to be Solved by the Invention

The prior-art PVA nonwoven fabric is generally produced from the PVA dissoluble in water at a higher temperature and, when being used as the chemical lace baser for example, suffers from the aforementioned problems. Where the prior-art partially or fully saponified PVA is used, the emanation of the acetic acid odor and the difficulty in melt-forming are problematic. In addition, bubbling occurs during dissolution of the nonwoven fabric in water, leading to a disadvantageous dissolution process. Therefore, a nonwoven fabric material suitable for practical applications has not been provided yet. Further, the water-soluble PVA filament disclosed in Patent Document 1 is also unsatisfactory with the need for recovery of solvents used in production and with difficulty in high-speed spinning and impossibility in producing the nonwoven fabric directly from the PVA material. Therefore, there is a demand for a PVA which is excellent in water solubility at a lower temperature, substantially free from the emanation of the acetic acid odor during the production of the nonwoven fabric, excellent in melt-formability, and more practical as a nonwoven fabric material.

In view of the foregoing, it is an object of the present invention to provide a water-soluble PVA filament which is excellent in water solubility at a lower temperature, easy to handle and substantially free from bubbling during dissolution thereof in water, and to provide a nonwoven fabric produced by using the water-soluble filament.

### Means for Solving the Problems

According to a first aspect of the present invention to achieve the aforementioned object, there is provided a water-soluble PVA filament of a material filament consisting essentially of a water-soluble PVA having a 1,2-diol structural unit represented by the following general formula (1):

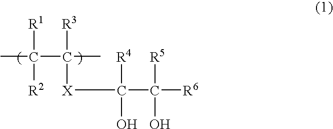

wherein R¹, R², R³, R⁴, R⁵ and R⁶, which may be the same or different, are each a hydrogen atom or a monovalent organic group, and X is a single bond or a connecting chain.

According to a second aspect of the present invention, there is provided a nonwoven fabric produced by using the aforementioned water-soluble PVA filament.

In order to solve the aforementioned problems, the inventors of the present invention conducted intensive studies to provide a water-soluble PVA having properties useful for a nonwoven fabric material. As a result, the specific water-soluble PVA having the 1, 2-diol structural unit represented by the general formula (1) has an improved water solubility at a lower temperature because the crystallization thereof is hindered due to the presence of the aforementioned structural unit. Further, the emanation of the acetic acid odor is suppressed, so that the working environment is improved and the rusting of the production machine is suppressed. In addition, the bubbling is suppressed during the dissolution of the nonwoven fabric in water.

With the aforementioned object thus achieved, the inventors attained the present invention.

### EFFECTS OF THE INVENTION

As described above, the present invention provides the water-soluble PVA filament of the material filament consisting essentially of the water-soluble PVA having the 1,2-diol structural unit represented by the general formula (1), and the nonwoven fabric produced by using the water-soluble PVA filament. Therefore, the nonwoven fabric is excellent in water solubility at a lower temperature, and substantially free from the bubbling during the dissolution thereof in water. In addition, a fully saponified PVA can be used for the melt-forming. This suppresses the emanation of the acetic acid odor, thereby improving the working environment. Therefore, the inventive nonwoven fabric is useful for a variety of applications requiring excellent water-solubility, for example, for embroidery bases such as chemical laces, automotive scratch protection materials, filters, medical surgery gowns and the like.

Where the 1,2-diol structural unit represented by the general formula (1) is a 1,2-diol structural unit represented by the aforementioned formula (1a):

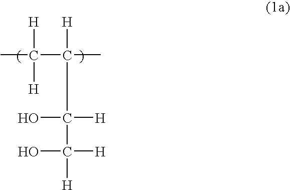

the PVA has a reduced crystallinity and a reduced melting point. Therefore, the PVA can be melt-formed at a temperature much lower than the decomposition temperature thereof, whereby an optimum forming temperature range is broadened to facilitate stable forming. Since the PVA has a smaller crystal size and has a higher melt tension because of its stronger hydrogen bond and higher intermolecular cohesion attributable to the presence of primary hydroxyl groups, a filament formed by melt-spinning the PVA can be taken up at a higher take-up speed on the order of 2000 to 4000 m/min and drawn at a higher draw ratio. As a result, the filament is improved in strength.

Where the water-soluble PVA having the 1,2-diol structural unit represented by the general formula (1) is a water-soluble PVA obtained by saponification of a copolymer of a vinyl ester monomer and a compound represented by the aforementioned general formula (2):

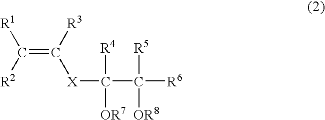

wherein R¹, R², R³, R⁴, R⁵ and Rb, which may be the same or different, are each a hydrogen atom or a monovalent organic group; X is a single bond or a connecting chain; and R⁷ and R⁸, which may be the same or different, are each a hydrogen atom or R⁹—CO— (wherein R⁹ is an alkyl group), the 1,2-diol structural unit can be easily and uniformly introduced into the water-soluble PVA in the production.

A feature of the present invention is that the PVA has the 1,2-diol structure at its side chain.

On the other hand, there is known a PVA which includes a greater amount (about 1.6 mol %) of main-chain 1,2-glycol bonds provided by increasing the proportion of head-to-head or tail-to-tail bonds of 1,3-glycol bonds (which are major main-chain bonds of the PVA) through polymerization of polyvinyl acetate at an elevated polymerization temperature (JP-A-2001-355175). However, the main-chain 1,2-glycol bonds are less effective for the reduction of the crystallinity than the side-chain 1,2-diol structure of the inventive PVA. Like the ordinary PVA, the aforementioned prior-art PVA includes secondary hydroxyl groups, so that the effects provided by the primary hydroxyl groups in the side-chain 1,2-diol structure cannot be expected from the prior-art PVA.

There is also known a PVA which is provided by copolymerization with an α-olefin having a terminal hydroxyl group and includes side-chain monohydroxyalkyl groups (JP-A-7 (1995)-179707). Such a PVA is liable to exhibit abnormal fluidity during melt-forming, thereby suffering from a problem associated with spinnability. In a production method disclosed in JP-A-7 (1995)-179707, only a hydroxyl-containing monomer is shown as an exemplary comonomer. However, such a hydroxyl-containing monomer has a limited solubility in a polymerization solvent, making it difficult to produce a highly modified product.

Unlike the inventive PVA having the side-chain 1,2-diol structure, the aforementioned prior-art PVA cannot expect improvement in melt tension by hydrogen bonds without an increase in the amount of hydroxyl groups by the modification. Therefore, the effect provided by the present invention cannot be expected from the prior art PVA, i.e., the high-speed take-up in the melt spinning is impossible.

### BRIEF DESCRIPTION OF THE DRAWINGS

FIG. 1 is a schematic diagram showing the construction of a measuring device to be used for a bubbling evaluation test in Examples and Comparative Examples.

### BEST MODE FOR CARRYING OUT THE INVENTION

A water-soluble PVA filament according to the present invention is obtained by using a material consisting essentially of a specific PVA. The water-soluble PVA filament is formed, for example, by melting and spinning the material into a filament form.

The specific PVA is a PVA having a 1,2-diol structural unit represented by the following general formula (1). That is, a feature of the present invention is that the specific PVA has the 1,2-diol structural unit represented by the general formula (1) and, like an ordinary PVA, further has a vinyl alcohol structural unit and a vinyl acetate structural unit in its other structural portion, and the proportions of these structural units are properly adjusted by a saponification degree.

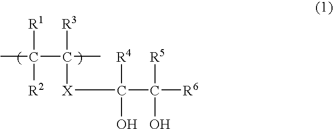

wherein R¹, R², R³, R⁴, R⁵ and R⁶, which may be the same or different, are each a hydrogen atom or a monovalent organic group, and X is a single bond or a connecting chain.

In the 1,2-diol structural unit represented by the general formula (1), R¹ to R³ and R⁴ to R⁶ in the formula (1), which may be the same or different, are each a hydrogen atom or a monovalent organic group. In consideration of the copolymerization reactivity of the monomers and industrially easy handling in a production process, it is particularly preferred that R¹ to R³ and R⁴ to R⁶ are each a hydrogen atom. As long as the resin properties are not significantly impaired, at least one of R¹ to R³ and R⁴ to R⁶ may be an organic group. The organic group is not particularly limited, but preferred examples thereof include C₁ to C₄ alkyl groups such as a methyl group, an ethyl group, a n-propyl group, an isopropyl group, a n-butyl group, an isobutyl group and a tert-butyl group. These organic groups may each have a substituent such as a halogen group, a hydroxyl group, an ester group, a carboxylic group or a sulfonic group.

In the 1,2-diol structural unit represented by the general formula (1), X in the formula (1) is preferably a single bond, which is free from any heat-stability impairing factor in the melt-spinning, excessive reduction in the crystallinity of the PVA and reduction in melt fluidity.

As long as the effects of the present invention are not impaired, X may be a connecting chain. The connecting chain is not particularly limited, but examples thereof include hydrocarbon groups such as alkylenes, alkenylenes, alkynylenes, phenylenes and naphthylenes (which may be substituted with a halogen such as fluorine, chlorine or bromine), —O—, —(CH₂O)ₘ—, —(OCH₂)ₘ—, —(CH₂O)ₘCH₂—, —CO—, —COCO—, —CO(CH₂)ₘCO—, —CO(C₆H₄)CO—, —S—, —CS—, —SO—, —SO₂—, —NR—, —CONR—, —NRCO—, —CSNR—, —NRCS—, —NRNR—, —HPO₄—, —Si(OR)₂—, —OSi(OR)₂—, —OSi(OR)₂O—, —Ti(OR)₂—, —OTi(OR)₂—, —OTi(OR)₂O—, —Al(OR)—, —OAl(OR)— and —OAl(OR)O—. In the aforementioned connecting chains, Rs, which may be the same or different, are each a given substituent. Examples of the substituent include a hydrogen atom and alkyl groups. Further, a repetition number m is a natural number. Among the aforementioned connecting chains, an alkylene group having a carbon number of not greater than 6 and —CH₂OCH₂— are preferred in terms of the stability during production or during use.

In the present invention, therefore, a PVA having a 1,2-diol structural unit represented by the following formula (1a) as the 1,2-diol structural unit represented by the general formula (1) is particularly preferably used as the specific PVA.

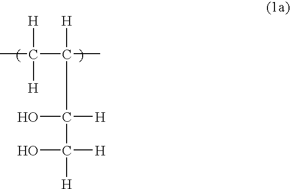

The specific PVA to be used in the present invention is prepared, for example, by any of the following three production methods (α), (β) and (γ), which are not limitative. Among these production methods, the production method (α) is preferably employed in consideration of production advantages such as proper polymerization and easy and uniform introduction of the 1,2-diol structural unit into the PVA, less problematic filament production from the resulting PVA, and the properties of the water-soluble PVA filament to be finally formed.

First, the production method (α) will be described.

In the production method (α), a copolymer is prepared by copolymerizing a vinyl ester monomer and a compound represented by the following general formula (2), and saponified, whereby the water-soluble PVA having the 1,2-diol structural unit represented by the general formula (1) is prepared.

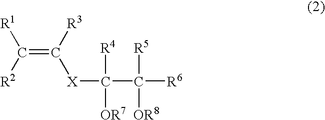

wherein R¹, R², R³, R⁴, R⁵ and R⁶, which may be the same or different, are each a hydrogen atom or a monovalent organic group; X is a single bond or a connecting chain; and R⁷ and R⁸, which may be the same or different, are each a hydrogen atom or R⁹—CO— (wherein R⁹ is an alkyl group).

Examples of the vinyl ester monomer include vinyl formate, vinyl acetate, vinyl propionate, vinyl valerate, vinyl butyrate, vinyl isobutyrate, vinyl pivalate, vinyl caprate, vinyl laurate, vinyl stearate, vinyl benzoate and vinyl versatate, among which vinyl acetate is preferably used from an economic viewpoint.

In the general formula (2), examples of R¹ to R⁶ and X include those described for the general formula (1). Further, R⁷ and R⁸, which may be the same or different, are each a hydrogen atom or R⁹—CO—. Where either or both of R⁷ and R⁸ are hydrogen atoms, it is often difficult to produce a highly modified product due to insufficient solubility in a polymerization solvent and, therefore, R⁹—CO— is preferred. In the R⁹—CO—, R⁹ is an alkyl group, and is preferably a methyl group, a propyl group, a butyl group, a hexyl group or an octyl group. The alkyl group may have a substituent such as a halogen group, a hydroxyl group, an ester group, a carboxylic group or a sulfonic group, as long as the copolymerization reactivity and a step subsequent to the copolymerization are not adversely affected.

Specific examples of a compound represented by the general formula (2) in which X is a single bond include 3,4-dihydroxy-1-butene, 3,4-diacyloxy-1-butenes, 3-acyloxy-4-hydroxy-1-butenes, 4-acyloxy-3-hydroxy-1-butenes and 3,4-diacyloxy-2-methyl-1-butenes. Specific examples of a compound represented by the general formula (2) in which X is an alkylene group include 4,5-dihydroxy-1-pentene, 4,5-diacyloxy-1-pentenes, 4,5-dihydroxy-3-methyl-1-pentene, 4,5-diacyloxy-3-methyl-1-pentenes, 5,6-dihydroxy-1-hexene and 5,6-diacyloxy-1-hexenes. Specific examples of a compound represented by the general formula (2) in which X is —CH₂OCH₂— or —OCH₂— include glycerin monoallyl ether, 2,3-diacetoxy-1-allyloxypropane, 2-acetoxy-1-allyloxy-3-hydroxypropane, 3-acetoxy-1-allyloxy-2-hydroxypropane, glycerin monovinyl ether and glycerin monoisopropenyl ether. These compounds may be used either alone or in combination.

Particularly, 3,4-diacyloxy-1-butenes which include hydrogen atoms as R¹ to R⁶, a single bond as X, R⁹—CO— as R⁷ and R⁸ and an alkyl group as R⁹ are preferred, among which 3,4-diacetoxy-1-butene including a methyl group as R⁹ is particularly preferred.

Where vinyl acetate is used as the vinyl ester monomer and copolymerized with 3,4-diacetoxy-1-butene, the monomer reactivity ratios are r(vinyl acetate)=0.710 and r(3,4-diacetoxy-1-butene)=0.701. For comparison, the monomer reactivity ratios for copolymerization with vinyl ethylene carbonate to be described later are r(vinyl acetate)=0.85 and r(vinyl ethylene carbonate)=5.4. Therefore, 3,4-diacetoxy-1-butene is more excellent in copolymerization reactivity with vinyl acetate.

The chain transfer constant of 3,4-diacetoxy-1-butene is Cx(3,4-diacetoxy-1-butene)=0.003 (65° C.). For comparison, the chain transfer constant of vinyl ethylene carbonate is Cx(vinyl ethylene carbonate)=0.005 (65° C.), and the chain transfer constant of 2,2-dimethyl-4-vinyl-1,3-dioxolane is Cx(2,2-dimethyl-4-vinyl-1,3-dioxolane)=0.023 (65° C.). Without any polymerization inhibiting factor, the polymerization degree is more easily increased, and the polymerization rate is unlikely to be reduced.

Further, a secondary product resulting from the saponification of the copolymer of 3,4-diacetoxy-1-butene is the same as a product derived from the vinyl acetate structural unit as a major structural unit. This provides a great industrial advantage without the need for provision of a special device or step for a post treatment.

An industrial grade 3,4-diacetoxy-1-butene is commercially available from Eastman Chemical Product Inc., and a reagent grade 3,4-diacetoxy-1-butene is commercially available from Across Co., Ltd. Further, 3,4-diacetoxy-1-butene produced as a secondary product in the production of 1,4-butandiol may be used.

It is also possible to use 3,4-diacetoxy-1-butene produced by a known isomerization reaction of 1,4-diacetoxy-1-butene using a metal catalyst such as palladium chloride.

A method of copolymerizing the vinyl ester monomer and the compound represented by the general formula (2) is not particularly limited, but a known polymerization method such as bulk polymerization, solution polymerization, suspension polymerization, dispersion polymerization or emulsion polymerization may be employed. Typically, the solution polymerization is employed.

A method of feeding the monomers for the copolymerization is not particularly limited, but a bulk feeding method, a separate feeding method, a continuous feeding method or the like may be employed. Dropping polymerization is preferred because the 1, 2-diol structural unit derived from the compound represented by the general formula (2) can be uniformly distributed in molecular chains of the polyvinyl ester polymer. Further, a polymerization method based on a HANNA equation which utilizes the reactivity ratio with respect to vinyl acetate is particularly preferred.

Typical examples of the solvent for the copolymerization reaction include lower alcohols such as methanol, ethanol, isopropyl alcohol, n-propanol and butanol, and ketones such as acetone and methyl ethyl ketone, among which methanol is industrially preferred.

The amount of the solvent to be used is properly selected according to the intended polymerization degree of the copolymer in consideration of the chain transfer constant of the solvent. Where the solvent is methanol, for example, a solvent (S)/monomer (M) weight ratio is properly selected from the range of S/M=0.01 to 10, preferably from the range of S/M=0.05 to 3.

A polymerization catalyst is used for the copolymerization. Examples of the polymerization catalyst include known radical polymerization catalysts such as azobisisobutyronitrile, acetyl peroxide, benzoyl peroxide and lauryl peroxide, and low-temperature active radical polymerization catalysts such as azobisdimethylvaleronitrile and azobismethoxydimethylvaleronitrile. The amount of the polymerization catalyst to be used, which depends upon the types of the monomers and catalysts, cannot be unconditionally determined, but may be properly selected depending on a required polymerization speed. Where azoisobutyronitrile or acetyl peroxide is used, for example, the amount thereof is preferably 0.01 to 0.7 mol %, more preferably 0.02 to 0.5 mol %, based on the amount of the vinyl ester monomer. A reaction temperature for the copolymerization reaction is determined depending on the solvent and a pressure to be used, but is preferably 30° C. to around a boiling point of the solvent. More specifically, the temperature is in the range of 35° C. to 150° C., preferably 40° C. to 75° C.

At completion of the polymerization, a known polymerization inhibitor for use in radical polymerization is preferably added to the reaction system. Examples of the polymerization inhibitor include m-dinitrobenzene, ascorbic acid, benzoquinone, a dimer of α-methylstyrene, and p-methoxyphenol.

Then, the resulting copolymer is saponified. For the saponification, the copolymer prepared through the aforementioned reaction is dissolved in a solvent such as an alcohol, and an alkaline catalyst or an acid catalyst is used. Typical examples of the solvent include methanol, ethanol, propanol and tert-butanol, among which methanol is particularly preferably used. The concentration of the copolymer in the alcohol is properly selected depending on the viscosity of the system, but typically selected from the range of 10 to 60 wt %. Examples of the catalyst to be used for the saponification include alkaline catalysts such as hydroxides and alcoholates of alkali metals including sodium hydroxide, potassium hydroxide, sodium methylate, sodium ethylate, potassium methylate and lithium methylate, and acid catalysts such as sulfuric acid, hydrochloric acid, nitric acid, metasulfonic acid, zeolites and cationic exchange resins.

The amount of the saponification catalyst is properly selected depending on the saponification method and an intended saponification degree. Where the alkaline catalyst is used, the amount thereof is preferably 0.1 to 30 mmol, more preferably 2 to 17 mmol, per mol of the total of the vinyl ester monomer and the 1,2-diol structural unit derived from the compound represented by the general formula (2). A reaction temperature for the saponification is not particularly limited, but is preferably in the range of 10° C. to 60° C., more preferably 20° C. to 50° C.

Next, the production method (β) will be described.

In the production method (β), a copolymer is prepared by copolymerizing the vinyl ester monomer and a compound represented by the following general formula (3), and then saponified and decarboxylated, whereby the water-soluble PVA having the 1,2-diol structural unit represented by the general formula (1) is prepared.

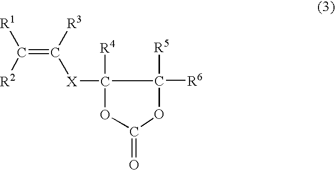

wherein R¹, R², R³, R⁴, R⁵ and R⁶, which may be the same or different, are each a hydrogen atom or a monovalent organic group, and X is a single bond or a connecting chain.

In the compound represented by the general formula (3), examples of R¹ to R⁶ and X in the formula (3) include those described for the general formula (1). Particularly, vinyl ethylene carbonate which includes hydrogen atoms as R¹ to R⁶ and a single bond as X is preferably used in consideration of availability and proper copolymerization.

The copolymerization of the vinyl ester monomer and the compound represented by the general formula (3) for the preparation of the copolymer and the saponification of the copolymer are achieved in the same manner as in the aforementioned production method (α).

No special process is required for the decarboxylation. The decarboxylation occurs simultaneously with the saponification, whereby an ethylene carbonate ring is opened to be converted into the 1,2-diol structure. It is also possible to cause the decarboxylation at a constant pressure (an atmospheric pressure (=1.013×10⁵ Pa) to 1×10⁷ Pa) at a high temperature (50° C. to 200° C.) without the saponification of a vinyl ester portion. In this case, the saponification may follow the decarboxylation.

If the saponification degree is lower or the decarboxylation is insufficient, the water-soluble PVA prepared by the production method (β) as having the 1,2-diol structural unit is liable to contain carbonate rings remaining at its side chains. Therefore, a filament formed from the PVA is liable to suffer from bubbling due to the decarboxylation during the melt-spinning, resulting in breakage or discoloration. Accordingly, consideration should be given to this drawback when the PVA is used.

Further, the production method (γ) will be described.

In the production method (γ), a copolymer is prepared by copolymerizing the vinyl ester monomer and a compound represented by the following general formula (4), and then saponified and deketalized, whereby the water-soluble PVA having the 1,2-diol structural unit represented by the general formula (1) is prepared.

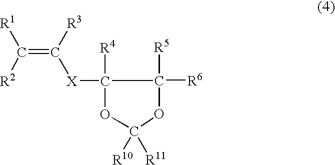

wherein R¹, R², R³, R⁴, R⁵ and R⁶, which may be the same or different, are each a hydrogen atom or a monovalent organic group; X is a single bond or a connecting chain; and R¹⁰ and R¹¹, which may be the same or different, are each a hydrogen atom or a monovalent organic group.

In the compound represented by the general formula (4), examples of R¹ to R⁶ and X in the formula (4) include those described for the general formula (1). In the formula (4), R¹⁰ and R¹¹, which may be the same or different, are each a hydrogen atom or a monovalent organic group. Preferred examples of the organic group include C₁ to C₄ alkyl groups such as a methyl group, an ethyl group, a n-propyl group, an isopropyl group, n-butyl group, isobutyl group and a tert-butyl group. The alkyl group may have a substituent such as a halogen group, a hydroxyl group, an ester group, a carboxylic group or a sulfonic group, as long as the copolymerization reactivity is not impaired. Particularly, 2,2-dimethyl-4-vinyl-1,3-dioxolane which includes hydrogen atoms as R¹ to R⁶, methyl groups as R¹⁰ and R¹¹ and a single bond as X is preferably used in consideration of availability and proper copolymerization.

The copolymerization of the vinyl ester monomer and the compound represented by the general formula (4) for the preparation of the copolymer and the saponification of the copolymer are achieved in the same manner as in the production method (α).

Where the alkaline catalyst is used for the saponification reaction, the copolymer is deketalized in an aqueous solvent (water, water/acetone or a lower alcohol containing solvent such as water/methanol) with the use of an acid catalyst after the saponification to be thereby converted into the 1,2-diol structure. In this case, examples of the acid catalyst include acetic acid, hydrochloric acid, sulfuric acid, nitric acid, metasulfonic acid, zeolites and cationic exchange resins.

Where the acid catalyst is used for the saponification, the copolymer is saponified and deketalized to be converted into the 1,2-diol structure without any special process.

In the present invention, the specific PVA may be prepared by using an unsaturated monomer for the copolymerization, as long as the object of the present invention is not impaired. The amount of the unsaturated monomer to be introduced is not particularly limited. However, introduction of an excessively great amount of the unsaturated monomer is disadvantageous, because the water solubility and the gas barrier property are impaired. Therefore, the amount is properly determined in consideration of this disadvantage.

Examples of the unsaturated monomer include: olefins such as ethylene, propylene, isobutylene, α-octene, α-dodecene and α-octadecene; unsaturated acids such as acrylic acid, methacrylic acid, crotonic acid, maleic acid, maleic anhydride and itaconic acid, and salts, monoesters and dialkyl esters of these unsaturated acids; nitrites such as acrylonitrile and methacrylonitrile; amides such as diacetone acrylamide, acrylamide and methacrylamide; olefin sulfonic acids such as ethylene sulfonic acid, allyl sulfonic acid and methallyl sulfonic acid, and salts of these olefin sulfonic acids; vinyl compounds such as alkyl vinyl ethers, dimethylallyl vinyl ketone, N-vinyl pyrrolidone and vinyl chloride; substituted vinyl acetates such as isopropenyl acetate and 1-methoxyvinyl acetate; and vinylidene chloride, 1,4-diacetoxy-2-butene, glycerin monoallyl ether and acetoacetyl group-containing monomers.

Other examples include: polyoxyalkylene-containing monomers such as polyoxyethylene (meth)allyl ether, polyoxyethylene (meth)acrylamide, polyoxypropylene (meth)acrylamide, polyoxyethylene (meth)acrylate, polyoxypropylene (meth)acrylate, polyoxyethylene [1-(meth)acrylamide-1,1-dimethylpropyl]ester, polyoxyethylene vinyl ether, polyoxypropylene vinyl ether, polyoxyethylene allylamine, polyoxypropylene allylamine, polyoxyethylene vinylamine and polyoxypropylene vinylamine; and cation group-containing monomers such as N-acrylamide ethyltrimethylammonium chloride, N-acrylamide propyltrimethylammonium chloride, 2-acryloxyethyltrimethylammonium chloride, 2-methacryloxyethyltrimethylammonium chloride, 2-hydroxy-3-methacryloyloxypropyltrimethylammonium chloride, allyltrimethylammonium chloride, methallyltrimethylammonium chloride, 3-butene trimethylammonium chloride, dimethyldiallylammonium chloride and diethyldiallylammonium chloride.

It is also possible to use a PVA including 1.6 to 3.5 mol % of a 1,2-diol bond introduced as a hetero bond into its main chain during the polymerization at a polymerization temperature of 100° C. or higher.

Like the water-soluble PVA prepared by the production method (β), the water-soluble PVA prepared by the production method (γ) as having the 1,2-diol structural unit is liable to suffer from detachment of acetal rings remaining at its side chains during the melt-spinning, and a filament formed from the PVA is liable to suffer from filament breakage due to bubbling. Therefore, consideration should be given to this drawback when the PVA is used.

The amount of the 1,2-diol bonds introduced in the specific PVA thus prepared, i.e., the amount of the 1,2-diol structural unit represented by the general formula (1), is preferably in the range of 0.1 to 30 mol %, more preferably 0.5 to 25 mol %, particularly preferably 3 to 16 mol %, for example, where the PVA is used for a nonwoven fabric. If the amount of the 1,2-diol bonds is excessively small, the PVA tends to have an increased crystallinity, a higher melting point and, hence, poorer water solubility. If the amount of the 1,2-diol bonds is excessively great, the PVA is highly adhesive to metals, resulting in adhesion to a machine, a die, a take-up roll and the like and difficulty in purging for lot changeover. Further, gelation occurs in a spinning machine due to thermal crosslinking and thermal degradation, making it difficult to stably perform a forming process.

The saponification degree of the specific PVA is not particularly limited, but is preferably not less than 60 mol %, more preferably not less than 75 mol %, particularly preferably not less than 90 mol %, further more preferably not less than 95 mol %. If the saponification degree is excessively low, the acetic acid odor tends to emanate, resulting in deterioration in working environment and rusting of the machine. In the present invention, the saponification degree is defined as the ratio (mol %) of the amount of the converted hydroxyl groups to the total amount of an ester portion in the vinyl ester monomer and an acetoxy portion or an acyloxy portion in the compound represented by the general formula (2).

The average polymerization degree of the specific PVA (as measured in conformity with JIS K 6726) is not particularly limited, but is preferably in the range of 150 to 2000, more preferably 200 to 1000, particularly preferably 200 to 750. If the average polymerization degree is excessively low, the PVA has an excellent drawability but tends to have a reduced strength. If the average polymerization degree is excessively high, the PVA fails to follow the high-speed take-up, making it difficult to form a nonwoven fabric.

The inventive water-soluble PVA filament is formed by using a material consisting essentially of the water-soluble PVA. The material is, for example, melt-spun into filaments.

The material consisting essentially of the water-soluble PVA is intended to include a material containing the water-soluble PVA alone, and is substantially defined as a material containing the water-soluble PVA in a proportion of not less than 80 wt %. Examples of a component of the material other than the water-soluble PVA include: plasticizers including aliphatic polyalcohols such as glycerin, ethylene glycol and hexanediol, and sugar alcohols such as sorbitol, mannitol and pentaerythritol; lubricants including saturated aliphatic amide compounds such as stearamide and ethylene bisstearamide, unsaturated aliphatic amide compounds such as oleamide, aliphatic metal salts such as calcium stearate, magnesium stearate and zinc stearate, and lower molecular weight polyolefins such as lower molecular weight ethylene and lower molecular weight propylene having a molecular weight of about 500 to about 10000; inorganic acids such as boric acid and phosphoric acid; and antioxidants, heat stabilizers, light stabilizers, UV absorbents, colorants, antistatic agents, surfactants, antiseptic agents, antibiotic agents, antiblocking agents, slip agents and fillers, which may be blended as required.

The melt-spinning method is not particularly limited, but a known melt-spinning machine is used for melt-spinning the material from a single nozzle or a compound nozzle. The spinning temperature is such that the water-soluble PVA is meltable and free from degradation, and is typically in the range of 120° C. to 230° C., preferably 140° C. to 225° C., particularly preferably 150° C. to 220° C. After the spinning, the resulting filament may be drawn as required. The drawing temperature is preferably 80° C. to 190° C. A draw ratio of not less than 2 is preferred for improvement of filament strength. As required, the filament may be crimped by means of a crimping machine. Then, the resulting filament is taken up. Thus, the inventive water-soluble PVA filament is provided.

The denier of the filament thus formed from the material containing the water-soluble PVA is properly determined depending on the filament forming method and the use purpose of the filament, but is preferably, for example, in the range of 0.005 to 50000 denier, more preferably 0.01 to 500 denier, particularly 0.05 to 5 denier. The filament having a denier within the aforementioned range has proper strength, flexibility and water solubility. Particularly, where a nonwoven fabric for a chemical lace base is produced from the filament, the nonwoven fabric satisfies both a strength requirement and a water solubility requirement at a lower temperature.

The inventive water-soluble PVA filament is typically used for a nonwoven or woven fabric, and particularly desirably used for a water-soluble nonwoven fabric. Further, the inventive water-soluble PVA filament may be used in a monofilament form, and may be wound around a planar base or into a hollow shape.

The production of the nonwoven fabric may be achieved, for example, by a spun-bonding method or a melt-blowing method which is suitable for production of a filament nonwoven fabric, or a method in which the aforementioned filament is cut into a predetermined length and a web of a staple nonwoven fabric is produced from the resulting staple fibers by a dry method such as a carding method or an air laying method. Particularly, the spun-bonding method is preferably used, because a highly strong filament nonwoven fabric can be produced directly from the material PVA.

In the spun-bonding method, the polymer is melt and kneaded by a melt-extruder, and a flow of the melted polymer is guided into a spinning head and ejected from nozzle holes. After filaments thus melt-spun are cooled by a cooling device, the filaments are drawn into an intended denier in a high-speed air stream by means of a suction device such as an air jet nozzle. Then, the filaments are spread and deposited on a moving collection surface to form a web. The resulting web is partly heat-pressed and wound up. Thus, a filament nonwoven fabric is produced.

The per unit area weight and the density of the nonwoven fabric produced from the inventive water-soluble PVA filament are properly determined depending on the use purpose. For example, the per unit area weight is preferably 5 to 200 g/m², particularly preferably 10 to 100 g/m², and the density is preferably 0.03 to 1 g/cm³. For the chemical lace base, the per unit area weight is preferably 10 to 70 g/m², particularly preferably 15 to 60 g/m², and the density is preferably 0.05 to 0.8 g/m³, particularly preferably 0.1 to 0.6 g/m³. If the per unit area weight and the density are excessively small, the absolute amount of the PVA filaments is smaller, resulting in insufficient strength. On the other hand, a nonwoven fabric having an excessively great per unit area weight and density is disadvantageous because breakage of a needle is liable to occur during embroidering on the nonwoven fabric.

The nonwoven fabric thus produced from the inventive water-soluble PVA filament has a characteristic property such that the water solubility at a lower temperature is excellent. In the present invention, the lower temperature is defined as a temperature in a range lower than a conventionally defined high temperature, e.g., a hot water temperature of about 90° C. More specifically, the lower temperature is defined as a temperature in the range of about 40° C. to about 70° C., particularly, a temperature not higher than 50° C. Where the nonwoven fabric is excellent in water solubility at a temperature in the aforementioned range, the nonwoven fabric is dissoluble in lower temperature water. When the water-soluble PVA nonwoven fabric is used as an embroidery base such as a chemical lace base, for example, discoloration of embroidery and degradation of embroidery threads can be advantageously suppressed.

Since the inventive nonwoven fabric has the aforementioned excellent properties, the nonwoven fabric is useful for chemical lace bases (high grade embroidery bases and the like), automotive scratch protection sheets, filters for solvents, medical surgery gowns, and the like.

Next, inventive examples will be described in conjunction with comparative examples. However, it should be understood that the present invention be not limited to these examples, as long as the invention is practiced without departing from the scope of the invention. Hereinafter, “%” is based on weight.

### EXAMPLE 1

### Preparation of Water-Soluble PVA-a

First, 1500 g of vinyl acetate, 2100 g of methanol and 180 g of 3,4-diacetoxy-1-butene (6 mol % based on the feed amount of vinyl acetate) were fed into a reaction can provided with a reflux condenser, a dropping funnel and a stirrer, and 0.05 mol % of azobisisobutyronitrile (based on the feed amount of vinyl acetate) was fed into the reaction can. Then, the temperature was elevated to initiate polymerization in a stream of nitrogen with stirring. When the polymerization ratio of vinyl acetate reached 80%, the polymerization was terminated by adding a predetermined amount of m-dinitrobenzene. In turn, unreacted vinyl acetate monomer was removed from the system by blowing methanol vapor into the system, whereby a methanol solution of the resulting copolymer was provided.

Subsequently, the methanol solution was diluted with methanol for adjusting the concentration of the copolymer at 35%, and the resulting solution was supplied into a kneader. The copolymer was saponified by adding a 2% methanol solution of sodium hydroxide in an amount of 8 mmol per mol of the total of a vinyl acetate structural unit and a 3,4-diacetoxy-1-butene structural unit in the copolymer while keeping the temperature of the solution at 40° C. In the course of the saponification, a saponification product was precipitated. After the saponification product grew into granules, the product was filtered, fully rinsed with methanol, and dried in a hot air drier. Thus, an intended water-soluble PVA-a was prepared.

The saponification degree of the water-soluble PVA-a thus prepared was 99.2 mol % as determined based on an alkali consumption required for hydrolysis of residual vinyl acetate and 3,4-diacetoxy-1-butene. The average polymerization degree (P) was 500 as determined in conformity with JIS K 6726. The amount of the 1,2-diol structural unit represented by the formula (1a) was 5.9 mol % as calculated based on measurement by 1H-NMR (using tetramethyl silane as an internal standard). Further, the melting point was 182° C.

Then, a filament formation material containing the water-soluble PVA-a alone was melt-spun.

### EXAMPLE 2

A filament formation material was prepared by blending glycerin as a plasticizer in a proportion of 5% based on the total amount with the water-soluble PVA-a, and then melt-spun. The melting point of the filament formation material was 177° C.

### EXAMPLE 3

A filament formation material was prepared by blending glycerin as a plasticizer in a proportion of 10% based on the total amount with the water-soluble PVA-a, and then melt-spun. The melting point of the filament formation material was 172° C.

### EXAMPLE 4

### Preparation of Water-Soluble PVA-b

First, 2700 g of vinyl acetate, 800 g of methanol and 240 g of 3,4-diacetoxy-1-butene (8 mol % based on the feed amount of vinyl acetate) were prepared, and 10% of the feed amount of the vinyl acetate was initially fed into a reaction can provided with a reflux condenser, a dropping funnel and a stirrer. Then, the residual vinyl acetate and the 3,4-diacetoxy-1-butene were dropped into the reaction can at constant rates in nine hours. In turn, 0.05 mol % of azobisisobutyronitrile (based on the feed amount of vinyl acetate) was fed into the reaction can. Then, the temperature was elevated to initiate the polymerization in a stream of nitrogen with stirring. When the polymerization ratio of vinyl acetate reached 87%, the polymerization was terminated by adding a predetermined amount of m-dinitrobenzene. In turn, unreacted vinyl acetate monomer was removed from the system by blowing methanol vapor into the system, whereby a methanol solution of the resulting copolymer was provided.

Subsequently, the methanol solution was diluted with methanol for adjusting the concentration of the copolymer at 35%, and the resulting solution was supplied into a kneader. The copolymer was saponified by adding a 2% methanol solution of sodium hydroxide in an amount of 8 mmol per mol of the total of a vinyl acetate structural unit and a 3,4-diacetoxy-1-butene structural unit in the copolymer while keeping the temperature of the solution at 40° C. In the course of the saponification, a saponification product was precipitated. After the saponification product grew into granules, the product was filtered, fully rinsed with methanol, and dried in a hot air drier. Thus, an intended water-soluble PVA-b was prepared.

The saponification degree of the water-soluble PVA-b thus prepared was 98.5 mol % as determined based on an alkali consumption required for hydrolysis of residual vinyl acetate and 3,4-diacetoxy-1-butene. The average polymerization degree (P) was 300 as determined in conformity with JIS K 6726. The amount of the 1,2-diol structural unit represented by the formula (1a) was 8.0 mol % as calculated based on measurement by 1H-NMR (using tetramethyl silane as an internal standard). Further, the melting point was 170° C.

Then, a filament formation material containing the water-soluble PVA-b alone was melt-spun.

### EXAMPLE 5

### Preparation of Water-Soluble PVA-c

A PVA-c was prepared in substantially the same manner as in Example 4, except that sodium hydroxide was added in an amount of 6.5 mmol.

The saponification degree of the water-soluble PVA-c thus prepared was 95 mol % as determined based on an alkali consumption required for hydrolysis of residual vinyl acetate and 3,4-diacetoxy-1-butene. The average polymerization degree (P) was 300 as determined in conformity with JIS K 6726. Further, the melting point was 157° C.

Then, a filament formation material containing the water-soluble PVA-c alone was melt-spun.

### COMPARATIVE EXAMPLE 1

### Preparation of Ordinary PVA-d

The polymerization was allowed to proceed in substantially the same manner as in Example 1, except that 1300 g of vinyl acetate and 2200 g of methanol were used and 3,4-diacetoxy-1-butene was not used. When the polymerization ratio reached 90%, the polymerization was terminated, and the saponification was allowed to proceed in the aforementioned manner by adding sodium hydroxide in an amount of 5 mmol per mol of a vinyl acetate structural unit. Thus, a PVA-d was prepared.

The saponification degree of the PVA-d thus prepared was 78.0 mol % as determined based on an alkali consumption required for hydrolysis of residual vinyl acetate. The average polymerization degree (P) was 500 as determined in conformity with JIS K 6726. Further, the melting point was 185° C.

Then, a filament formation material containing the PVA-d alone was melt-spun.

### COMPARATIVE EXAMPLE 2

### Preparation of Ordinary PVA-e

A PVA-e was prepared in substantially the same manner as in Comparative Example 1, except that sodium hydroxide was added in an amount of 4 mmol.

The saponification degree of the PVA-e thus prepared was 72.0 mol % as determined based on an alkali consumption required for hydrolysis of residual vinyl acetate. The average polymerization degree (P) was 500 as determined in conformity with JIS K 6726. Further, the melting point was 170° C.

Then, a filament formation material was prepared by blending polyethylene glycol (PEG) (having a weight average molecular weight of 300) in a proportion of 50% based on the total amount with the PVA-e, and melt-spun.

### COMPARATIVE EXAMPLE 3

### Preparation of Ordinary PVA-f

A PVA-f was prepared in substantially the same manner as in Comparative Example 1, except that sodium hydroxide was added in an amount of 8 mmol.

The saponification degree of the PVA-f thus prepared was 98.5 mol % as determined based on an alkali consumption required for hydrolysis of residual vinyl acetate. The average polymerization degree (P) was 500 as determined in conformity with JIS K 6726. Further, the melting point was 220° C.

Then, a filament formation material containing the PVA-f alone was melt-spun.

With the use of the filament formation materials of Examples and Comparative Examples thus prepared, nonwoven fabrics were produced in the following manner, and properties of the nonwoven fabrics were evaluated. The results are shown in Table 1.

With the use of a spinning tester (Fuji melt-spinning tester available from Fuji Filter Manufacturing Co., Ltd.), the filament formation materials were each melt-spun into filaments (fibers) from a spinneret (0.5×1-28H) through a 40-μm filter element at an extrusion rate of 12 g/min with a screw extrusion portion kept at 190° C. and with a spinning nozzle portion kept at 220° C. The filament take-up speed was set at a highest possible speed free from filament breakage. Then, the filaments were pressed and fusion-bonded by a heat press (at a temperature lower by 10° C. than the melting point at a pressure of 10 MPa for two minutes). Thus, a nonwoven fabric (having a per unit area weight of 40 g/m² and a thickness of 0.5 mm) was produced.

For evaluation of the drawability of each of the filaments, the thickness of the filament was calculated as a value relative to the thickness of the filament spun from the filament formation material of Example 1. The results are shown in Table 1.

### Water Solubility

First, 1.5 g of each of the nonwoven fabrics was put in water (50° C.) contained in a constant temperature water bath having a volume of 500 mL, and stirred at 300 rpm by Three-One Motor. Time required for complete dissolution of the nonwoven fabric as visually checked was determined. The results were evaluated based on the following criteria.

◯: Nonwoven fabric completely dissolved in water within 30 minutes.
Δ: Nonwoven fabric completely dissolved in water in a period longer than 30 minutes and not longer than 1 hour.
X: Nonwoven fabric did not completely dissolved in water even after a lapse of 1 hour.

### Odor (Acetic Acid Odor)

The nonwoven fabrics were each organoleptically checked for odor (acetic acid odor) by five examiners.

### Evaluation of Bubbling

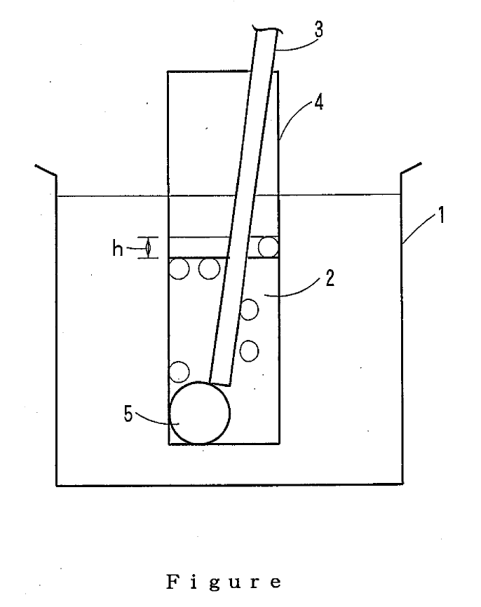

The nonwoven fabrics were each completely dissolved at a concentration of 1 wt % and at a concentration of 4 wt % in purified water, whereby test solutions were prepared. Then, as shown in FIG. 1, the test solutions 2 were each poured in a 1-liter graduated cylinder 4 in a constant temperature water bath 1, and air was blown into the test solution 2 from a pump (not shown) through a pipe 3. At this time, a bubbling height h (mm) was measured. After the air blowing was stopped, the state of defoaming was visually observed.

Measurement conditions are as follows:
Water temperature: 40° C.
Concentrations in test solutions: 1 wt % and 4 wt %
Amount of solution: 200 g
Measurement vessel 4: 1-liter graduated cylinder
Air blowing amount: 200 ml/min for 5 minutes from the start of the air blowing (using an air stone 5 as an air outlet)

TABLE 1

| Filament | Water solubility | | Evaluation of bubbling (mm) | |
|---|---|---|---|---|
| drawability* | (50° C.) | Odor | 1 wt % | 4 wt % |

Example

| | | | | | | |
|---|---|---|---|---|---|---|
| 1 | 5.9 mol modified with saponification degree of 99.2 and | 1.0 | Excellent ◯ | No | 0-10 | 0-10 |
| | P = 500 | | | | | |
| 2 | 5.9 mol modified with saponification degree of 99.2 and | 0.9 | Excellent ◯ | No | 0-10 | 0-10 |
| | P = 500, and blended with 5% of glycerin | | | | | |
| 3 | 5.9 mol modified with saponification degree of 99.2 and | 0.5 | Excellent ◯ | No | 0-10 | 0-10 |
| | P = 500, and blended with 10% of glycerin | | | | | |
| 4 | 8.0 mol modified with saponification degree of 98.5 and | 0.1 | Excellent ◯ | No | 0-10 | 0-10 |
| | P = 300 | | | | | |
| 5 | 8.0 mol modified with saponification degree of 95 and | 0.08 | Excellent ◯ | No | 0-10 | 0-10 |
| | P = 300 | | | | | |

Comparative Example

| | | | | | | |
|---|---|---|---|---|---|---|
| 1 | Saponification degree of 78 and P = 500 | 10.4 | Slightly clouded Δ | Yes | ≧1000 (without | ≧1000 (without |
| | | | | | defoaming) | defoaming) |
| 2 | Saponification degree of 72 and P = 500, and blended with 5% | 9.5 | Slightly clouded Δ | Yes | ≧1000 (without | ≧1000 (without |
| | of PEG (300) | | | | defoaming) | defoaming) |
| 3 | Saponification degree of 98.5 and P = 500 | 1.2 | Insoluble X | No | ≧1000 (without | ≧1000 (without |
| | | | | | defoaming) | defoaming) |

*A value determined relative to the thickness of filament prepared in Example 1.

As can be understood from the results, the nonwoven fabrics of Examples were excellent with excellent water solubility without acetic acid odor. In addition, the evaluation of the bubbling of the solutions having concentrations expected to be observed when the nonwoven fabrics are actually dissolved in water indicates that the bubbling was suppressed with a bubbling height not greater than 10 mm.

On the other hand, the nonwoven fabrics of Comparative Examples 1 and 2 produced from the ordinary unmodified PVAs with lower saponification degrees were poorer in water solubility, and suffered from emanation of the acetic acid odor. Further, the evaluation of the bubbling indicates that the bubbling was remarkable with a bubbling height not less than 1000 mm without defoaming. The nonwoven fabric of Comparative Example 3 was free from the acetic acid odor, but insoluble in water. In addition, the evaluation of the bubbling indicates that the bubbling was remarkable with a bubbling height not less than 1000 mm without defoaming.

As apparent from the aforementioned results, the nonwoven fabrics of Examples are easy to handle without the emanation of the odor, and excellent in water solubility at a lower temperature. Where these nonwoven fabrics are each used as an embroidery baser for example, the embroidery base is dissoluble in water at a lower temperature on the order of 50° C., so that discoloration of embroidery and deterioration of embroidery threads can be suppressed. Therefore, the nonwoven fabrics of Examples are very useful.

### INDUSTRIAL APPLICABILITY

The nonwoven fabric produced from the water-soluble PVA filament according to the present invention is usable, for example, as chemical lace bases such as high grade embroidery bases, automotive scratch protection sheets, filters for solvents, medical surgery gowns, and the like.

1. A water-soluble polyvinyl alcohol resin filament comprising a water-soluble polyvinyl alcohol resin comprising a 1,2-diol structural unit represented by the following general formula (1): 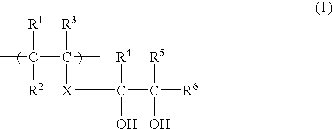
wherein R¹, R², R³, R⁴, R⁵ and R⁶, which may be the same or different, are each a hydrogen atom or a monovalent organic group, and X is a single bond or a connecting chain.

2. A water-soluble polyvinyl alcohol resin filament as set forth in claim 1, wherein the 1,2-diol structural unit represented by the general formula (1) is present in a proportion of 0.1 to 30 mol % in the water-soluble polyvinyl alcohol resin.

3. A water-soluble polyvinyl alcohol resin filament as set forth in claim 1, wherein the water-soluble polyvinyl alcohol resin has a saponification degree of 60 to 99.9 mol %.

4. A water-soluble polyvinyl alcohol resin filament as set forth in claim 1, wherein the water-soluble polyvinyl alcohol resin has an average polymerization degree of 150 to 2000.

5. A water-soluble polyvinyl alcohol resin filament as set forth in claim 1, wherein the 1,2-diol structural unit represented by the general formula (1) is a 1,2-diol structural unit represented by the following formula (1a):

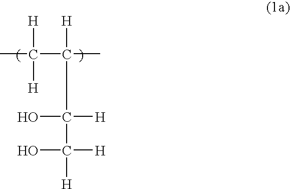

6. A water-soluble polyvinyl alcohol resin filament as set forth in claim 1, wherein the water-soluble polyvinyl alcohol resin is a water-soluble polyvinyl alcohol resin obtained by saponification of a copolymer of a vinyl ester monomer and a compound represented by the following general formula (2): 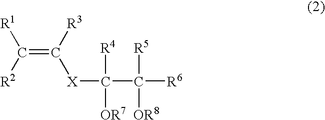
wherein R¹, R², R³, R⁴, R⁵ and R⁶, which may be the same or different, are each a hydrogen atom or a monovalent organic group; X is a single bond or a connecting chain; and R⁷ and R⁸, which may be the same or different, are each a hydrogen atom or R⁹—CO— (wherein R⁹ is an alkyl group).

7. A water-soluble polyvinyl alcohol resin filament as set forth in claim 1, having a filament diameter of 0.005 to 50000 denier.

8. A nonwoven fabric produced by using a water-soluble polyvinyl alcohol resin filament as recited in claim 1.

9. A nonwoven fabric as set forth in claim 8, which has a per unit area weight of 5 to 200 g/m².
